(19) United States
(12) Patent Application Publication
(10) Pub. No.: US 2022/0123412 A1
(43) Pub. Date: Apr. 21, 2022

(54) BATTERY PACK

(71) Applicant: BLACK & DECKER INC., New Britain, CT (US)

(72) Inventors: Timothy J. Hennesy, Baltimore, MD (US); Michael Varipatis, Fallston, MD (US)

(21) Appl. No.: 17/451,755

(22) Filed: Oct. 21, 2021

Related U.S. Application Data
(60) Provisional application No. 63/094,445, filed on Oct. 21, 2020.

(51) Int. Cl. H01M 50/244; H01M 50/213; H01M 10/653

(52) U.S. Cl. CPC H01M 50/244; H01M 10/653; H01M 50/213

(57) ABSTRACT

The present disclosure is directed to a battery pack including features for addressing overheating of the battery pack and battery cells in the battery pack. The battery pack incorporates a battery cell holder that includes features for housing phase change materials to move heat away from the battery cells. The phase change material may be positioned between adjacent battery cells. The phase change material may be positioned within the cell holder.

### RELATED APPLICATIONS

This application claims priority under 35 U.S.C. § 119(e) to U.S. Provisional Patent Application No. 63/094,445, filed Oct. 21, 2021, titled “Battery Pack.”

### TECHNICAL FIELD

This application relates to a battery pack, and in particular to a power tool battery pack having a structure for effective cooling of battery cells.

### BACKGROUND

Electric tools include an electric motor and require a source of electricity to power the motor. Electric tools may be broken down into two groups: (1) corded electric tools that source electricity through a cord plugged into a source of alternating current and (2) cordless electric tools that source electricity from a battery. Cordless electric tools may be broken down into two groups: (1) tools that use an internal, integrated battery and (2) tools that use a removable battery pack.

The cordless electric tools that use a removable battery pack and the removable battery pack that provides electricity (energy/power) to a cordless electric tool requires an interface between the tool and the pack. The tool includes a tool portion/aspect/element of the combination interface and the pack includes a pack portion/aspect/element of the combination interface. The interface allows the tool and the pack to couple/mate and decouple/unmate with each other such that when the tool and the pack are coupled/mated the pack will provide power to the tool and will stay affixed to the tool during operation of the combination.

The interface is configured and defined such that only tools and packs that are intended to work with each will be able to fully couple/mate. Particularly, different tool and pack manufacturers configure and define the interface between their tools and packs such that a tool of one manufacturer will not fully couple/mate with a battery pack of another manufacture. In some configurations, the interface may include one or more guide rails that allow insertion of the battery pack along a receiving axis until electrical contact is made between battery terminals and a terminal block of the tool.

A battery pack typically includes a series of battery cells connected in a series, parallel, or series/parallel configuration. The battery cells may be electrically connected in series to increase the voltage rating of the battery pack, in parallel to increase the current and/or charge capacity of the battery pack, or a combination of series and parallel configuration. For example, a battery pack marketed as a 20V Max battery pack in the power tool industry with a nominal voltage of approximately 18V may include a single string of five battery cells (5S1P), or multiple such strings of five battery cells connected in parallel (5SxP, where x>1). The battery pack current capacity may be increased by increasing the number of parallel strings of battery cells. In this example, the parallel connections are made at the ends of the strings, though it should be understood that parallel connections may be made at any point within the strings or even between each cell. In an embodiment, the battery pack may be a convertible battery pack where the strings of cells may be switchable configured in series or parallel depending on the voltage requirement of the power tool. U.S. Pat. No. 9,406,915, which is incorporated herein by reference in its entirety, describes examples of such a convertible battery pack.

Battery cells may be made of, for example, lithium or lithium ion material. Battery cells are typically cylindrical in shape and are arranged in parallel within the battery pack housing. Battery cells generate heat during use, particularly in applications where the power tool draws significant amount of current from the battery pack. A thermistor is typically provided within the battery pack to monitor the temperature of the battery cells. The thermistor may generate a voltage signal corresponding to the temperature. This signal may be sent to the power tool to cut off battery pack discharge, or it may be sent to a switch provided within the battery pack to cut off flow of current, when the battery pack temperature exceeds a temperature threshold. However, with increased use of battery packs with high-power power tools and increase in manufacturing of higher current and higher capacity battery cells, the temperature of the battery pack can frequently exceed the temperature threshold of the cells prior to completely discharging the cells. When this condition occurs, the battery pack must cool down prior to being used or charged. Therefore, an effective mechanism for thermal management and proper cooling of the battery cells within the battery pack is needed.

### SUMMARY

An aspect of the present invention includes a battery pack. An exemplary embodiment of the battery pack includes features for addressing increases in temperature of the battery pack and battery cells housed in the battery pack.

A first embodiment of a battery pack may include a housing, a battery core, positioned in the housing. The battery core may include a set of battery cells and a battery cell holder. The battery cell holder may include a set of battery cell receptacles, a set of halfpipes, and a set of channels. The set of battery cells may be received in the set of battery cell receptacles. Each battery cell receptacle of the set of battery cell receptacles may include a planar base. The set of halfpipes may be arranged adjacent to the planar base. A channel of the set of channels may be formed between adjacent halfpipes.

The aforementioned first embodiment may include a configuration wherein a channel of the set of channels is formed on both sides of each halfpipe of the set of halfpipes.

The aforementioned first embodiment may include a configuration wherein the battery cells of the set of battery cells have a longitudinal axis and a length along the longitudinal axis, at least one of the halfpipes of the set of halfpipes have a length approximately equal to the length of the battery cells, and at least one of the channels of the set of channels have a length approximately equal to the length of the battery cell and the length of the halfpipe.

In the aforementioned first embodiment the at least one of the channels of the set of channels has a substantially triangular cross section.

In the aforementioned first embodiment each battery cell is in direct contact with at least one of the battery cell receptacles of the set of battery cell receptacles.

In the aforementioned first embodiment the at least one battery cell receptacle of the set of battery cell receptacles includes an upper portion and a lower portion.

In the aforementioned first embodiment the upper portion faces the lower portion.

In the aforementioned first embodiment the halfpipes of the upper portion and the halfpipes of the lower portion form cylindrical chambers sized to form-fittingly receive at least one battery cell of the set of battery cells.

In the aforementioned first embodiment the set of battery cell receptacles has two battery cell receptacles.

In the aforementioned first embodiment at least one channel of the set of channels is formed adjacent to the planar base.

In the aforementioned first embodiment at least one channel of the set of channels extends along the length of the halfpipe and between lower portions of adjacent halfpipes.

In the aforementioned first embodiment the phase change material is Polyethylene Oxide (PEO).

In the aforementioned first embodiment the phase change material is paraffin wax.

The aforementioned first embodiment may also include a set of plugs, a plug of the set of plugs plugged into an end of at least one of the channels of the set of channels.

In the aforementioned first embodiment the phase change material is Polyethylene Oxide (PEO).

In the aforementioned first embodiment the phase change material is paraffin wax.

In the aforementioned first embodiment the phase change material is a solid material having a melting temperature below a maximum temperature rating of the battery cells of the set of battery cells.

The aforementioned first embodiment may also include at least one channel of the set of channels being closed-ended on a first end and open-ended on a second end to receive the phase change material.

In the aforementioned first embodiment the phase-change material is pre-molded as an elongated bar with a substantially triangular cross-sectional shape and sized to be form-fittingly received at least one of the channels of the set of channels.

In the aforementioned first embodiment the phase-change material is poured into at least one channel of the set of channels in liquid form and allowed to solidify.

The aforementioned first embodiment may also include a set of plugs, a plug of the set of plugs plugged into the open-ended second end of the at least one channel of the set of channels.

These and other advantages and features will be apparent from the description and the drawings.

### BRIEF DESCRIPTION OF THE DRAWINGS

The drawings described herein are for illustration purposes only and are not intended to limit the scope of this disclosure in any way.

FIG. 1 depicts a perspective view of a power tool battery pack, according to an embodiment.

FIG. 2 depicts a perspective view of a power tool battery pack having an alternative structure, according to an embodiment.

FIG. 3 depicts a perspective view of a conventional battery core including side caps for restraining battery cells, according to an embodiment.

FIG. 4 depicts a perspective view of the conventional battery core including one battery cell, according to an embodiment.

FIG. 5 depicts a perspective view of a battery core including cell holders for improved cooling of battery cells, according to an embodiment.

FIG. 6 depicts a perspective view of the battery core with conductors and terminals removed, according to an embodiment.

FIG. 7 depicts a side view of the battery core with conductors and terminals removed, according to an embodiment.

FIG. 8 depicts a perspective view of a cell holder, according to an embodiment;

FIG. 9 depicts a perspective view of a cell holder including phase-changing material encapsulated within the channels, according to an embodiment.

FIG. 10 depicts a partially exploded view of the cell holder of FIG. 9, according to an embodiment.

FIG. 11 depicts a fully exploded view of the cell holder of FIG. 9, according to an embodiment.

FIG. 12 depicts a perspective view of a battery pack including phase-change material in contact with battery cells, according to an embodiment.

FIG. 13 depicts a perspective view of the battery pack with the upper housing removed including a flexible inner wall, according to an embodiment.

FIG. 14 depicts a perspective view of the battery pack with the upper housing and the flexible inner wall removed showing a battery core and a printed circuit board, according to an embodiment.

FIG. 15 depicts a perspective view of battery core, according to an embodiment.

FIG. 16 depicts a bottom perspective view of the flexible inner wall, according to an embodiment.

FIG. 17 depicts a perspective view of the battery pack with the upper housing and the flexible inner wall removed, including phase-change material disposed within the lower housing, according to an embodiment.

FIG. 18 depicts a rear cross-sectional view of the battery pack with the seal in the normal state, according to an embodiment.

FIG. 19 depicts a rear cross-sectional view of the battery pack with the seal in the expanded state, according to an embodiment.

FIG. 20 depicts a perspective view of a battery core including phase-change material for improved cooling of battery cells, according to an embodiment.

FIG. 21 depicts a perspective view of the battery core with some components removed, according to an embodiment.

FIG. 22 depicts a perspective view of the battery core with a core cap removed to show the phase-change material, according to an embodiment.

FIG. 23 depicts a perspective view of the battery core with the core cap and the phase-change material removed, according to an embodiment.

FIG. 24 depicts another perspective view of the battery core showing only some of the battery cells, according to an embodiment.

FIGS. 25 and 26 depict perspective exploded views of the battery core, according to an embodiment.

FIG. 27 is a graph illustrating temperature levels and voltage levels of several example embodiments of battery packs during discharge.

### DETAILED DESCRIPTION

The following description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

FIG. 1 depicts a perspective view of a power tool battery pack 10, according to an example embodiment. In an example embodiment, the battery pack 10 includes a lower housing 12 and an upper housing 14 that together house a battery core (not shown) including a set of battery cells (not shown). In an example embodiment, the upper housing 14 includes a plurality of terminal slots 16 arranged to receive a plurality of tool terminals to make an electrical connection with a power tool, one or more guide rails 18 that form elongate grooves 20 along the sides of the plurality of terminal slots 16, and a latch 22 that releasably locks the battery pack 10 to the power tool.

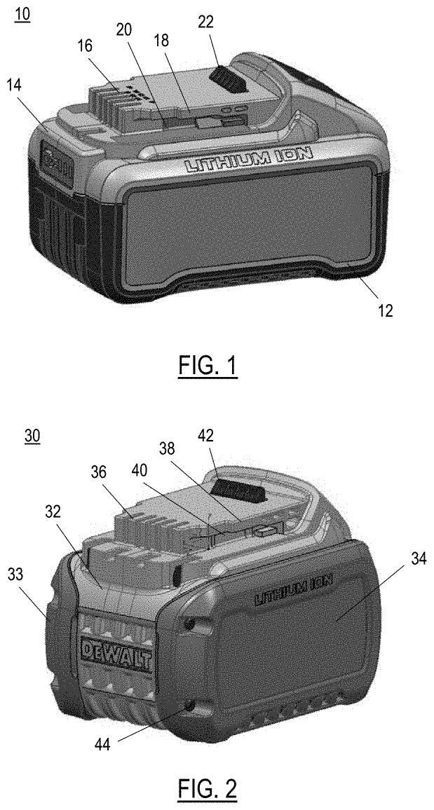

FIG. 2 depicts a perspective view of an alternative power tool battery pack 30, according to an example embodiment. In an example embodiment, the battery pack 30 includes a main housing 32 and two side walls 33 and 34 that together houses a battery core (not shown) including a set of battery cells (not shown). In an example embodiment, the side walls 33 and 34 are mounted on opposite sides of the main housing 32 around the battery core and fastened together via a set of screws 44. In an embodiment, the main housing 32 includes a plurality of terminal slots 36 arranged to receive a plurality of tool terminals to make an electrical connection with a power tool, one or more guide rails 38 that form elongate grooves 40 along the sides of the plurality of terminal slots 36, and a latch 42 that releasably locks the battery pack 30 to the power tool.

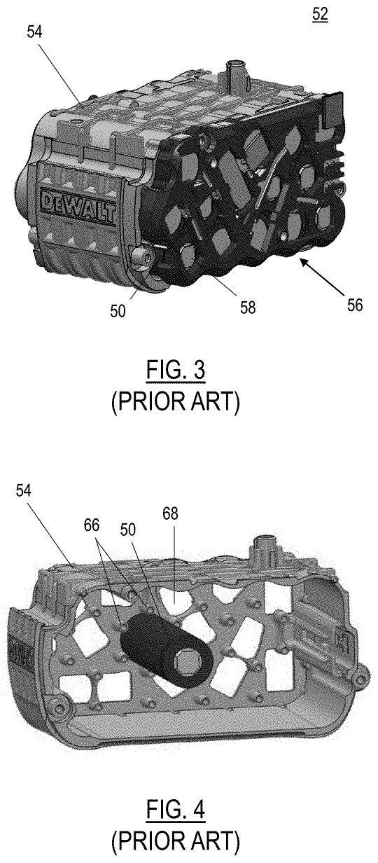

FIG. 3 depicts a perspective view of a conventional battery core 52, according to an embodiment. In this example, the battery core 52 includes a main housing 54. The main housing 54 may be similar in structure to the main housing 32 of the battery pack 30 of FIG. 2 and may be similarly contained by two side walls 33 and 34, though it should be understood that the battery core 52 may be utilized in other forms of battery packs. In this example, the main housing 54 includes an open end for receiving a series of battery cells 50 therein. A battery cap 56 is mounted on the open end of the main housing 54 to retain the ends of the battery cells 50. The battery cap 56 includes openings 58 that support conductors (not shown) for making electrical connections between the battery cells 50.

FIG. 4 depicts a perspective view of the conventional main housing 54 showing a single battery cell 50, according to an embodiment. As shown here, the main housing 54 includes a series of openings 68 that, similar to openings 58 of the battery cap 56, support conductors (not shown) for making electrical connections between the battery cells 50. Further, the main housing 54 includes a series of posts 66 formed peripherally around the end of each battery cell 50 to support the battery cells 50 within the battery core 52. Although not shown in these figures, the battery cap 56 may also include similar posts to similarly support the battery cells 50. These posts securely maintain the battery cells 50 parallel to each other with small air gaps in between.

In this conventional battery core 52, each of the battery cells 50 is in physical contact with the main housing 54 (including the posts 68) on one end and the battery cap 65 (including its posts) on the other end. The remaining surface area of each battery cell 50, which constitutes the significant majority of the surface area, is surrounded by air contained within the battery core 52. Air has been found to have a relatively low thermal conductivity and a relatively low specific heat capacity. Thermal conductivity refers to a measure of the ability of the material to conduct heat, and specific heat capacity refers to the amount of heat required to raise the temperature of a unit of mass of a given material by a given amount. The higher the thermal conductivity of a material, the quicker it can transfer heat away from one medium to another. The higher the specific heat capacity of a material, the more heat it can absorb from the surrounding medium. Air therefore is not very effective at carrying heat away or absorbing heat from the battery cells 50 in the conventional battery core 52 described above. In fact, it has been found that even materials such as plastic, that are commonly considered to be thermally insulative have much greater thermal conductivity and specific heat capacity than air and are better suited to carry heat away or absorb heat from the battery cells.

An obvious solution is to place metal heat sinks in contact with battery cells within the battery pack. However, metals are electrically conductive and undesirable in low impedance circuits present in lithium battery packs, where the presence of a metal may cause interference and/or electrical shortage. Also, metals such as brass have very high level of thermal conductivity and very low specific heat capacity, and therefore can reach the temperature level of the battery cells too quickly and without absorbing significant heat from the battery cells. Such metals can only be effective for heat transfer if they are exposed to outside environment via, for example, a heat sink including external fins on the battery pack housing. Even then, due to very high thermal conductivity of the heat sink, the fins need be shielded from direct contact by the user.

Embodiments of the invention as described in this disclosure offer solutions for capturing battery cells in material having suitable levels of thermal conductivity and/or specific heat capacity to improve thermal performance of battery packs.

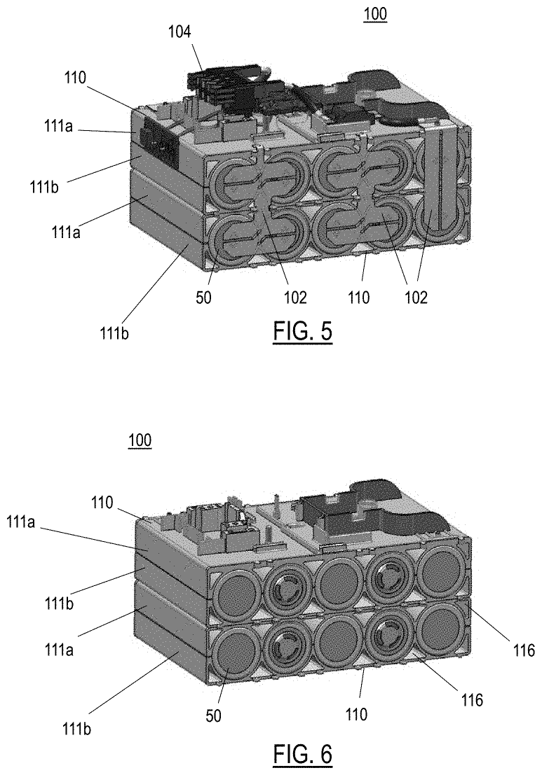

An embodiment of the invention is described herein with reference to FIGS. 5-8. In this embodiment, a cell holder is provided in direct contact with the battery cells within the pack core to reduce surface contact between the battery cells and air, thus increasing thermal conductivity and heat absorption from the battery cells.

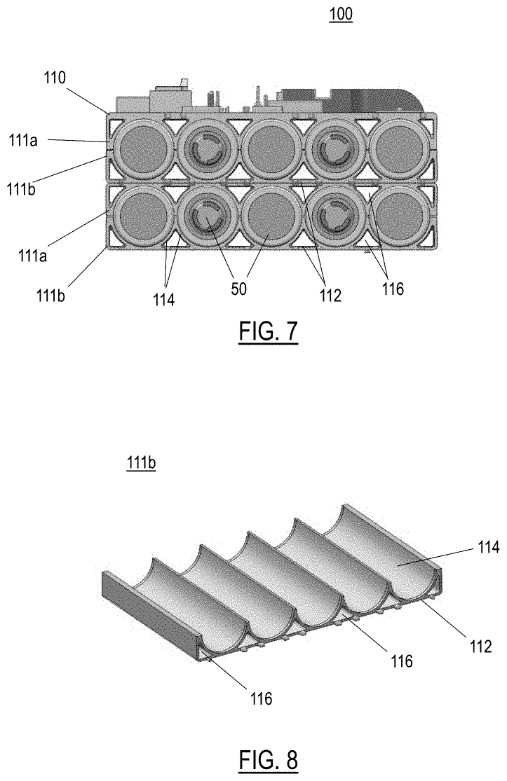

FIG. 5 depicts a perspective view of a battery core 100 including a cell holder 110 for improved cooling of battery cells 50, according to an embodiment. The cell holder 110 may include a plurality of battery cell receptacles 111 for receiving the battery cells 50. Each receptacle 111 may include an upper portion 111a and a lower portion 111b (as illustrated in FIG. 7). The upper portion 111a may be have the same physical configuration as the lower portion 111b. FIG. 6 depicts a perspective view of the battery core 100 with conductors 102 and terminals 104 removed for better visibility of the cell holder 110, according to an embodiment. FIG. 7 depicts a side view of the battery core 100 with conductors 102 and terminals 104 removed for better visibility of the cell holder 110, according to an embodiment. As illustrated in FIG. 7, the upper portion 111a faces the lower portion 111b in a mirror image manner. In an alternate embodiment, the battery cell receptacle 111 (specifically, the upper portion 111a and the lower portion 111b) of the cell holder 110 may be formed as a single component. FIG. 8 depicts a perspective view of the lower portion 111b of the cell holder 110, according to an embodiment.

As shown in these figures, the cell holder 110 (and the battery cell receptacles in particular) is sized and shaped to be in direct contact with the battery cells 50. The upper portion 111a and the lower portion 111b of the cell holder 110 are stacked to form cylindrical battery cell chambers sized to form-fittingly receive the battery cells 50 therein. The cell holder 110, particularly the battery cell receptacles 111, increases the surface contact of the battery cells 50 with plastic material rather than air, thus increasing the overall thermal efficiency of the battery pack.

In an example embodiment, a set of two battery cell receptacles 111 are provided for two rows of battery cells 50. As the upper portion 111a and the lower portion 111b of the battery cell receptacle 111 are generally the same, only the lower portion 111b will be described in detail below. These elements may also be found on the upper potion 111a. The lower portion 111b of the battery cell receptacles 111 include a planar base 112 and a set of halfpipes 114 arranged adjacently on the planar base 112. The elongate channels 116 may be formed between two adjacent halfpipes 114. The elongate channels may be formed adjacent to the planar base 112. The channels 116 have substantially triangular cross-sectional shapes and extend between lower portions of adjacent halfpipes 114. The upper portion 111a and the lower portion 111b of the cell holders 110 are stacked with halfpipes 114 facing each other forming cylindrical chambers sized to form-fittingly receive the battery cells 50. For a battery pack including multiple rows of battery cells 50, two battery cell receptacles 111 may be stacked on top of each other.

This arrangement significantly reduces, and in fact almost eliminates, surface contact between the battery cells 50 and air within the battery core 100. In an embodiment, the battery cell receptacles 111 are made of plastic material that possess material strength to provide structural support for the battery cells 50, but also possess thermal properties for efficient cooling of the battery cells. An example of such material is HDPE (High Density Poly-Ethylene), which has a thermal conductivity of 0.42 W/mK and specific heat capacity of 2.25 J/gK. By comparison, air has a thermal conductivity of 0.025 W/mK and specific heat capacity of 1 J/gK. Other examples of preferred plastic material for this application include GFN (Glass-Filled Nylon), which has a thermal conductivity of 0.35 W/mK and specific heat capacity of 1.5 J/gK, and PC-ABS (Polycarbonate/Acrylonitrile-Butadiene-Styrene Terpolymer Blend), which has a thermal conductivity of 0.2 W/mK and specific heat capacity of 2 J/gK. It was found that use of any of these materials, in particular HDPE, significantly improves thermal efficiency of the battery pack.

In an embodiment, the channels 116 may be provided as air pockets. Alternatively, the channels 116 may be filled with any of the plastic material described above. In an example embodiment, the plastic material within the channels 116 may be the same as or different from the plastic material used for construction of the battery cell receptacles 111.

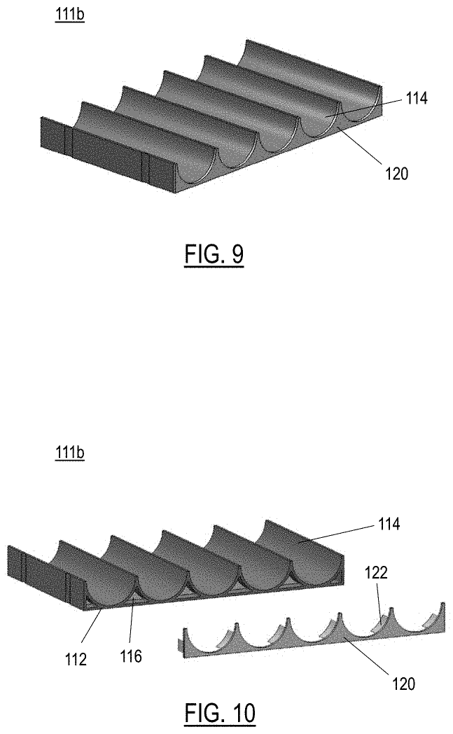

In yet another example embodiment, as described herein with reference to FIGS. 9-11, the heat sinking effect of the battery cell receptacles 111 may be further increased by providing a highly thermally capacitive phase change material within the channels 116 of the battery cell receptacles 111.

In an example embodiment, the phase change material is a solid material having a melting temperature below the maximum temperature rating of the battery cells 50. In an example embodiment, the phase change material also includes a high heat of fusion (also known as enthalpy of fusion), which enables it to absorb a significant amount of heat from the battery cells 50 when its melting temperature is reached. An example of such material is paraffin wax, which has a melting point of approximately between 46° C. to 68° C., preferably approximately 50° C. to 55° C. Paraffin wax has a thermal conductivity of approximately 0.18 W/mK to 0.25 W/mK, which is lower than the plastic material discussed above, and a specific heat capacity of 2.1 J/gK to 3.26 J/gK, which is higher than most of the plastic material discussed above. Importantly, paraffin wax has a heat of fusion of between 200 J/gK to 270 J/gK, allowing it to absorb a significant amount of heat at approximately its melting point.

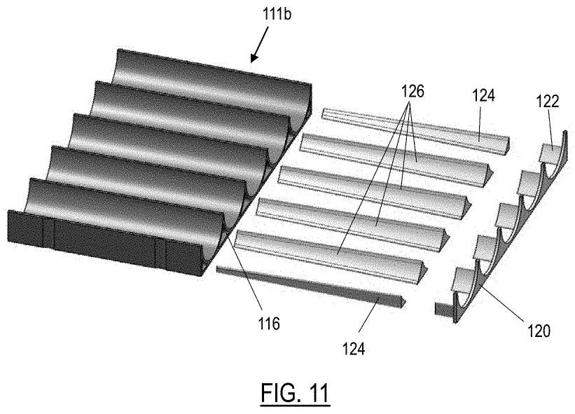

FIG. 9 depicts a perspective view of a battery cell receptacle 111b including the phase-changing material within the channels 116, according to an embodiment. FIG. 10 depicts a partially exploded view of the battery cell receptacle 111b, according to an embodiment. FIG. 11 depicts a fully exploded view of the battery cell receptacle 111b, according to an embodiment.

As shown in these figures, the channels 116 of the battery cell receptacle 111b may be closed-ended on a first end and open-ended on a second end to receive the phase change material 126 therein. In an example embodiment, the phase-change material 126 may be pre-molded as elongated bars with substantially triangular cross-section shapes and sized to be form-fittingly received in the channels 116. Alternatively, the phase-change material 126 may be poured into the channels 116 in liquid form and allowed to solidify.

In an example embodiment, an end cap 120 is mounted at the second end of the battery cell receptacle 111b to seal the phase-change material 126 within the channels 116. In an example embodiment, the end cap 120 includes a set of plugs 122 shaped to be securely plugged into second, open-ends of the battery cell receptacle 111b to form a liquid-tight seal around the phase-change material 126.

As discussed above, the phase-change material 126 may be any material having a melting temperature below the maximum temperature rating of the battery cells 50. While paraffin wax and similar phase-change material are highly effective in absorbing heat from the battery cells 50 at their melting points, they are susceptible to high thermal expansion in liquid form. Paraffin wax can expand by approximately 10% in volume when changing phase and becomes a low viscosity fluid. In an example embodiment, the length and/or volume of the phase-change material 126 within each of the channels 116 is approximately 50% to 90% smaller, preferably 60% to 80% smaller, than the length and/or volume of each of the channels 116 to provide air pockets for expansion of the phase-change material 126. Disposition of the phase-change material 126 within the channels 116 in this manner allows for controlled expansion of the material without potential damage to the battery cells 50 or the battery pack housing.

Another example embodiment may use a composite phase change material which is shape stable, such as polyethylene glycol (PEG). A formed geometry of this or other phase change material can be disposed within the channels 116 to absorb significant heat from the battery cells. An advantage of this design is to utilize the improved structure of the cell holder 110 to mechanically support the battery cells while also transferring heat effectively to the phase change material.

Another example embodiment may use heat absorbing materials such as graphite, metals or composites disposed within the channels to absorb heat without directly touching the battery cells. These materials can also be designed to transfer heat to external surfaces of the battery pack where there are more substantial surface areas and exposure to cooling air.

In another example embodiment, the heat absorbing materials used to fill the channels 116 may vary based on the channel location within the cell holder. Alternatively, some of the channels may remain unpopulated. In other words, these channels are filled with air or filled with the plastic material of the cell holder 110 during the molding/forming process.

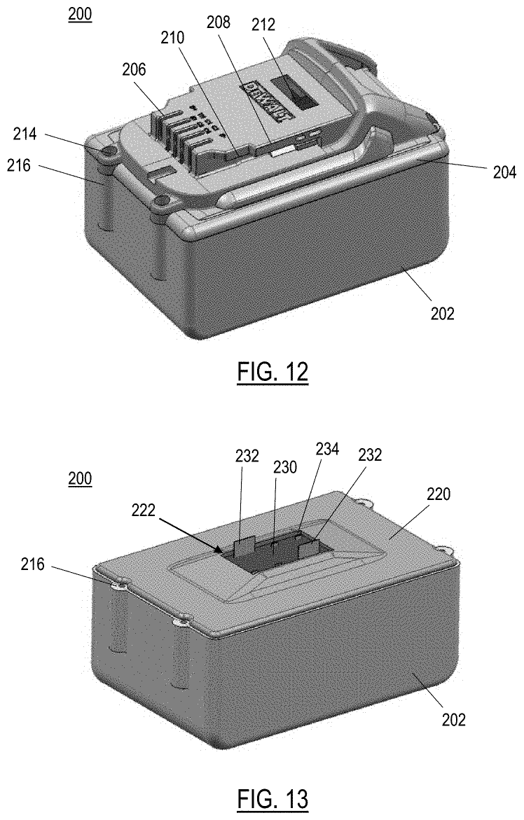

An alternative example embodiment of the invention is described herein with reference to FIGS. 12-19. In this example embodiment, the phase-change material is provided in direct contact with the battery cells for improved thermal conductivity and heat absorption. In addition, a flexible wall is provided within the battery pack to allow for expansion of the phase-change material in high heat without damaging the battery cells or other battery pack components.

FIG. 12 depicts a perspective view of a battery pack 200 including a phase-change material in contact with the battery cells, according to an example embodiment. As shown here, similar to FIG. 1, the battery pack 200 includes a lower housing 202 and an upper housing 204 fastened together via a series of fasteners (not shown) received vertically through a series of openings 214 of the upper housing 204 and fastened to corresponding threaded openings 216 of the lower housing 202. In an embodiment, the upper housing 204 includes a plurality of terminal slots block 206 arranged to receive a plurality of tool terminals to make an electrical connection with a power tool, one or more guide rails 208 that form elongate grooves 210 along the sides of the plurality of terminal slots 206, and a latch 212 that releasably locks the battery pack 200 to the power tool.

FIG. 13 depicts a perspective view of the battery pack 200 with the upper housing 204 removed, according to an embodiment. As shown here, the battery pack 200 includes a flexible inner wall 220 that separates the upper housing 204 from the lower housing 202. In an embodiment, the flexible inner wall 220 is disposed approximately along a mating plane of the upper and lower housings 204 and 202. The battery cells (not shown) are contained within the lower housing 202 below the flexible inner wall 220. In an embodiment, a circuit board 230 is supported within an opening 222 of the inner flexible wall 220. The circuit board 230 supports the connectors 232 and 234 that facilitate electrical connections between the battery cells and the terminal block 206.

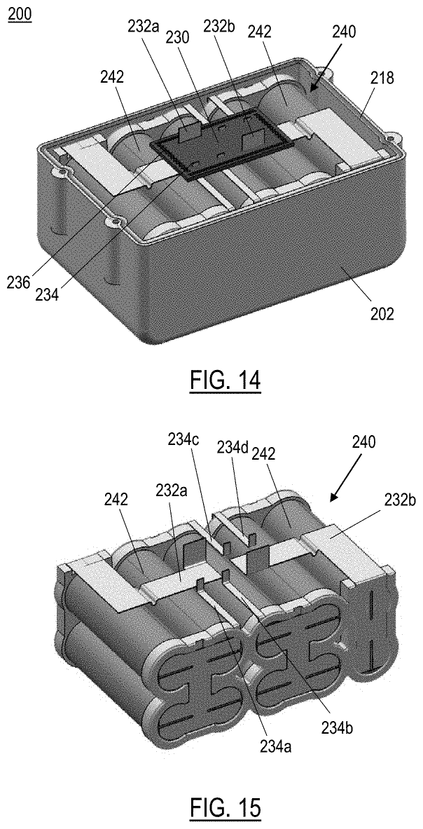

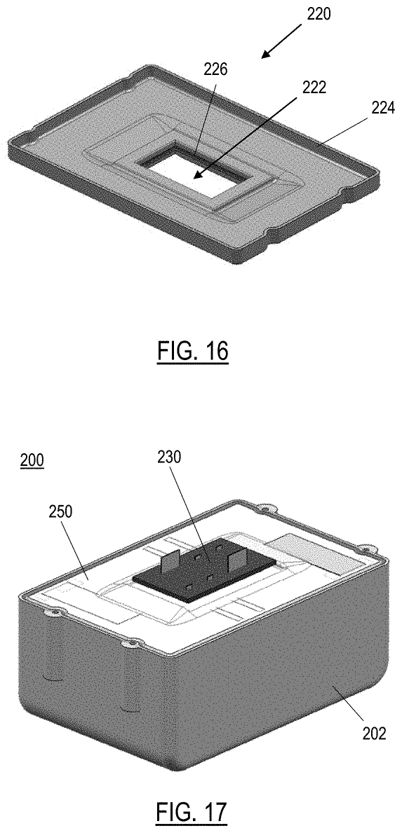

FIG. 14 depicts a perspective view of the battery pack 200 with the upper housing 204 and the flexible inner wall 220 removed, showing the battery core 240 including a plurality of battery cells 242 connected to the circuit board 230 via the connectors 232 and 234, according to an embodiment. FIG. 15 depicts a perspective view of the battery core 240 including the battery cells 242 and the connectors 232 and 234, according to an embodiment. FIG. 16 depicts a bottom/inner perspective view of the flexible inner wall 220, according to an embodiment. FIG. 17 depicts a perspective view of the battery pack 200 with the upper housing 204 and the flexible inner wall 220 removed, including a phase-change material 250 disposed within the lower housing 202, according to an embodiment.

As shown in these figures, the circuit board 230 includes a series of slots that allow the connectors 232 and 234 to project upwardly therethrough. The periphery of the connectors 232 and 234 may be soldered or glued to provide an airtight and/or watertight seal between the connectors 232 and 234 and the circuit board 230.

In an embodiment, two connectors 232a, 232b are coupled to B+ and B− nodes of the battery cells 242, respectively and each connector 234a, 234b, 234c, 234d is coupled to one the nodes between electrically adjacent battery cells 242 to sense voltages of each of the battery cells 242. In an embodiment, each of the connectors 232 and 234 are coupled to ends of the battery cells 242, extend over the battery core 240, and extend perpendicularly upwardly through the slots of the circuit board 230. In this manner, connectors 232 and 234 have some flexibility to move away from the battery core 240 with upward movement of the circuit board 230.

In an embodiment, the circuit board 230 also includes a series of peripheral slots 236 that improves molding of the flexible inner wall 220 around the circuit board 230. In an embodiment, the molding process of the flexible inner wall 220 forms a groove 226 around the opening 222 that receives the peripheral area (slots/wall/rails) of the circuit board 223 and allows the mold material to flow through the peripheral slots 236. This arrangement provides an airtight and/or watertight seal between the circuit board 230 and the flexible inner wall 220.

In an embodiment, the lower housing 202 includes an upper peripheral groove 218 that receives a peripheral wall 224 of the flexible inner wall 220, forming an airtight and/or watertight tongue and groove seal between the lower housing 202 and the flexible inner wall 220.

In an embodiment, the phase-change material 250 may be poured into the lower housing 202 in liquid form and allowed to solidify around the battery core 240. Alternatively, the phase-change material 250 may be pre-molded around the battery core 240 prior to insertion into the lower housing 202. In yet another embodiment, the phase change material 250 may be pre-molded in a shape capable of receiving the battery core 240 therein in the assembly process.

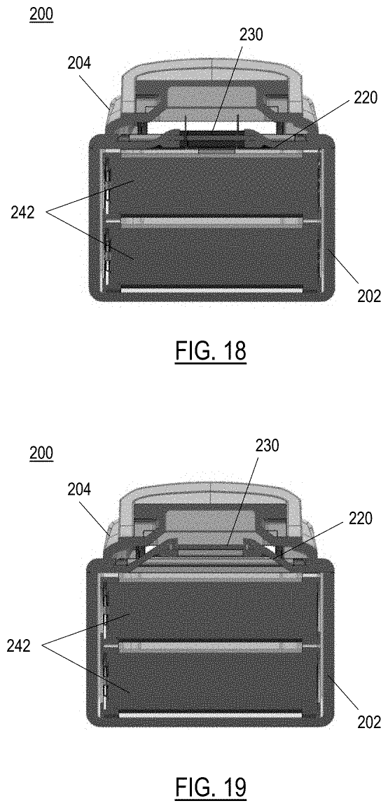

FIG. 18 depicts a rear cross-sectional view of the battery pack 200 with the flexible inner wall 220 in the normal state, according to an embodiment. FIG. 19 depicts a rear cross-sectional view of the battery pack 200 with the flexible inner wall 220 in the expanded state, according to an embodiment. As shown in these figures, the flexible inner wall 220 is expanded with an application of force from its normal state, where the flexible inner wall 220 is in line with an upper portion of the lower housing 202, to an expanded state, where the flexible inner wall 220 expands into the upper housing 204. In an embodiment, in normal conditions, the phase-change material 250 is contained within the lower housing 202 and sealed via the flexible inner wall 220. Thermal volumetric expansion of the phase-change material, particularly as it enters a liquid state, applies an upward force to the flexible inner wall 220 and causes it to expand into the upper housing 204 while maintaining the seal between the flexible inner wall 220 and the lower housing 202. In an embodiment, the flexible inner wall 220 accommodates volumetric expansion of the phase-change material 250 by approximately 10% to 20% while maintaining proper sealing and containment for the phase-change material.

While phase-change materials such as paraffin wax are highly effective for thermal management of battery cells, sealing and containment of the material to account for thermal expansion does present challenges and added costs. In the embodiment of FIGS. 9-11, the phase-change material is required to be provided at volumes less than the volume of the channels to account for thermal expansion. This arrangement does not take advantage of the maximum space available for disposition of the phase-change material 124. In the embodiment of FIGS. 12-19, the pack core is required to be sealed via a flexible inner wall that can absorb the thermal expansion of the phase-change material while including proper sealing between the components to avoid leakage. This arrangement adds to manufacturing cost and material complexity.

To overcome these challenges, in an embodiment, the phase-change material may be crystalline-to-amorphous phase-change material having a crystalline-to-amorphous transition point that is lower than the maximum temperature rating of the battery cells 50. An example of such material is Polyethylene Oxide (PEO). PEO has a specific heat capacity comparable to paraffin wax, but it has significant heat of fusion of approximately 120 J/gK, which is approximately half that of paraffin wax. Although PEO is not as effective at absorbing heat from the cells, its volumetric expansion is small and almost negligible. This allows PEO to be used in fixed volume containers without risking damage due to pressure caused by the volume change when changing phase.

Referring once again to FIGS. 9-11, according to an embodiment of the invention, the phase-change material 126 may be made fully or partially from crystalline-to-amorphous phase-change material such as PEO. Since thermal expansion of PEO material is negligible, in an embodiment, bars of the phase-change material 126 may be provided with substantially the same length and/or volume as channels 116 (minus the length and/or volume of plugs 122). Further, since the material is in an amorphous state after the transition point, the end cap 120 is not required to form an airtight or even a watertight seal with the battery cell receptacles 111. Rather, the seal needs to be of sufficient quality to be impermeable to amorphous, highly viscous material.

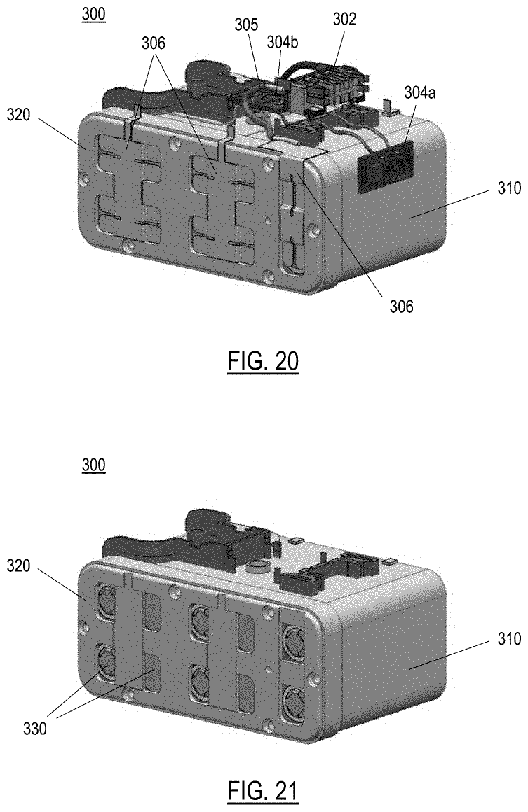

In an alternative embodiment, as described herein with reference to FIGS. 20-26, crystalline-to-amorphous phase-change material such as PEO may be provided in direct contact with the battery cells. Again, since thermal expansion of PEO material is negligible, this embodiment may be constructed without a need for a flexible wall to account for volumetric expansion of the material within the battery pack.

FIG. 20 depicts a perspective view of a battery core 300 including phase-change material for improved cooling of battery cells, according to an embodiment. In an embodiment, a battery core 300 may be utilized in the battery packs 10 or 30 described above with reference to FIGS. 1 and 2. In an embodiment, the battery core 300 provides a tight enclosure to fully seal the phase-change material. In an embodiment, the battery core 300 includes a main housing 310 that including an open end for receiving a set of battery cells 330 and a core cap 320 that mates with the open end of the main housing 310 to enclose the battery cells 330. The battery core 300 in this figure is depicted with a terminal block 302, a first circuit board 304a and a second circuit board 304b on which a thermistor 305 is mounted, and a set of connectors/straps 306 for facilitating connection between the terminal block 302 and the battery cells.

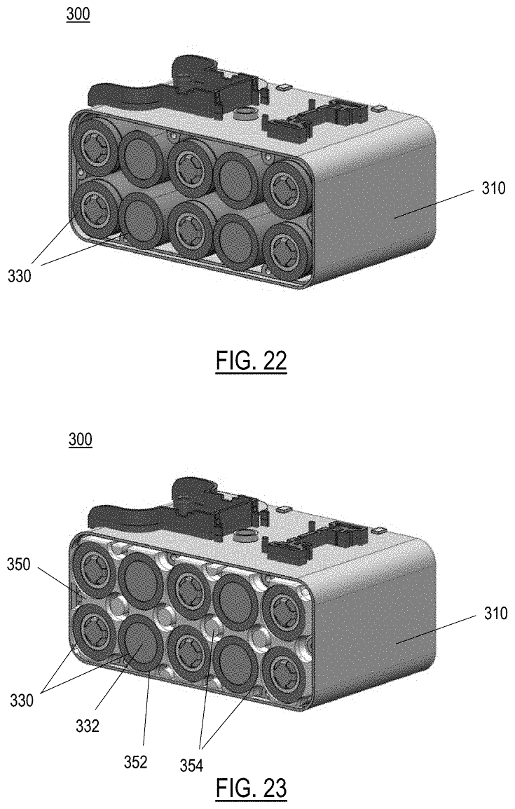

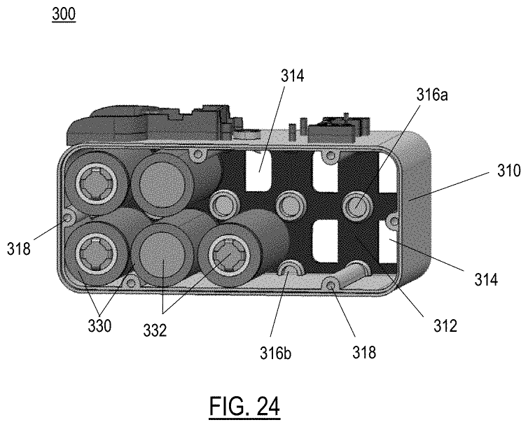

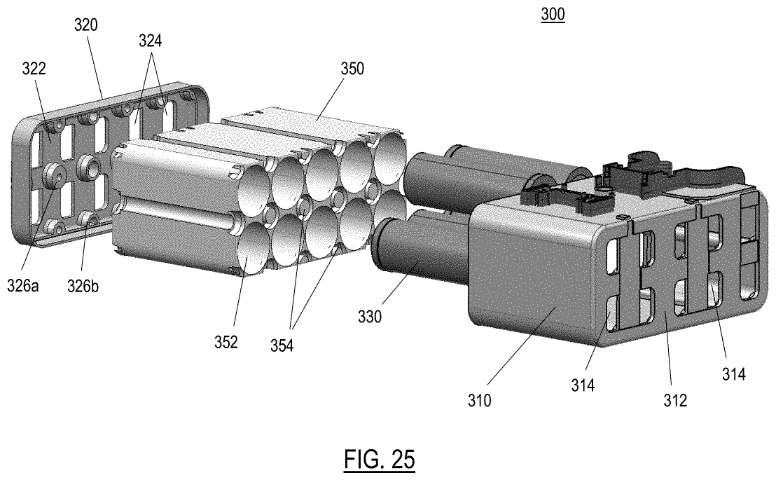

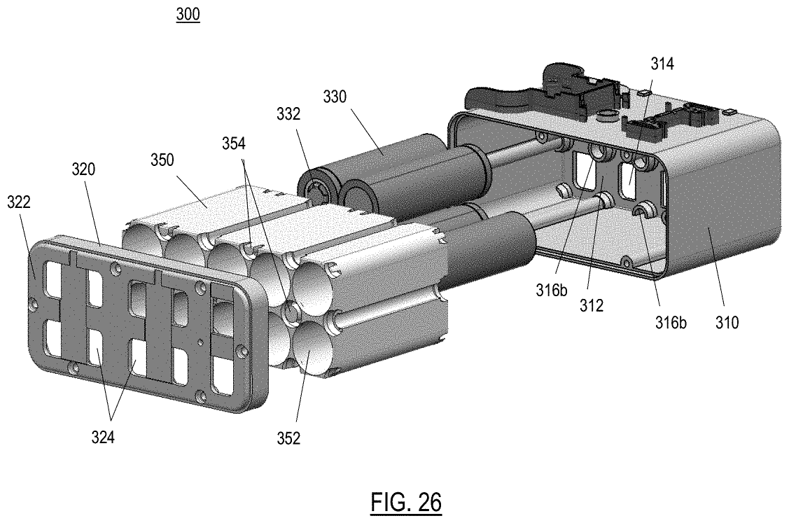

FIG. 21 depicts a perspective view of the battery core 300 without the connectors 306, the terminal block 302, and the circuit boards 304a, 304b, according to an embodiment. FIGS. 22 and 23 depict perspective view of the battery core 300 without the core cap 320, respectively without and with the phase-change material 350 provided within the main housing 310, according to an embodiment. FIG. 24 depicts another perspective view of the battery core 300 showing some of the battery cells 330, according to an embodiment. FIGS. 25 and 26 depict perspective exploded views of the battery core 300, according to an embodiment.

As shown in these figures, the main housing 310 of the battery core 300 includes a rear wall 312 having a set of openings 314 aligned with a set of terminals 332 of the battery cells 330. The set of openings 314 may have a smaller area than a cross-sectional area of the battery cells 330 such that the peripheral body of each battery cells 330 comes into contact with the rear wall 312. Similarly, a core cap 320 includes a front wall 322 having a set of openings 324 aligned with the set of terminals 332 of battery cells 330. The openings 324 have a smaller area than a cross-sectional area of the battery cells 330 such that the peripheral body of each of the battery cells 330 comes into contact with the front wall 322.

In an embodiment, positioned between rows of battery cells 330 on one end (i.e., a rear end) are a series of annular rims 316a provided on the main housing 310 offset with respect to the openings 314. Similarly, positioned between rows of battery cells 330 on the other end (i.e., front end) are a series of annual rims 326a provided on the core cap 320 offset with respect to the openings 324. Further, positioned between the walls of the main housing 310 and the rear end of the battery cells 330 are a series of semi-annular rims 316b offset with respect to the openings 314. Similarly, positioned between the walls of the core cap 320 and the front end of battery cells 330 are a series of semi-annular rims 326b offset with respect to the openings 324. The rims 316a and 316b are sized to axially project into the gap between the battery cells 330 by approximately 1-2 mm on the rear end of the battery cells 330, and the rims 326a and 326b are sized to axially project into the gap between the battery cells 330 by approximately 1-2 mm on the front end of the battery cells 330. The rims 316a, 316b, 326a, and 326b cooperate structurally to support the battery cells 330 within the battery core 330 while maintaining openings between adjacent battery cells 330.

In an embodiment, the phase-change material 350 is provided within the battery core 300 for absorption of heat directly from the battery cells 330 without an intermediary plastic component. In an embodiment, the phase-change material 350, as discussed above, is preferably crystalline-to-amorphous phase-change material such as PEO with limited thermal expansion. In an embodiment, the phase-change material 350 is pre-molded in the shape depicted in FIGS. 25 and 26, including cylindrical openings 352 sized to form-fittingly receive the battery cells 330, and end circular and semi-circular grooves 354 formed to engage the rims 316a and 316b of the main housing 310 and the rims 326a and 326b of the core cap 320. Alternatively, in an embodiment, the phase-change material 350 may be poured into the main housing 310 in its liquid and/or amorphous state after proper alignment and positioning of the battery cells 320 within the main housing 310.

In an embodiment, the core cap 320 is then mounted on the open end of the main housing 310 to form an enclosure around the battery cells 330 and the phase-change material 350. Once the core cap 320 is mounted, the battery cells 330 make direct contact with the rear wall 312 of the main housing 310 and the front wall 322 of the core cap 320. This contact forms a seal tight enough to prevent flow of the phase-change material 350 out of the battery core 300 even in its amorphous state. In an embodiment, a glue or other sealant may be provided to strengthen the seal between the battery cells 330 and the rear and front walls 312 and 322.

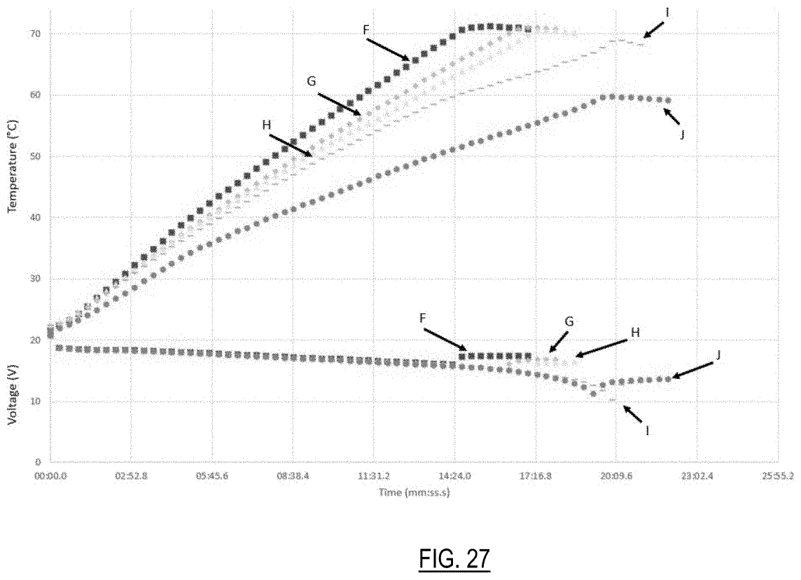

FIG. 27 presents information regarding a variety of example battery packs during discharge. This information includes the temperature and corresponding voltage of each example battery pack during discharge.

As background, each of the battery packs uses the same type of Li-Ion battery cell—these example battery packs use Samsung 50S battery cells. These battery cells have an undervoltage or discharge threshold of approximately 2 volts, under load. Other battery cells may have other discharge thresholds. Such battery cells are within the scope of this application. These example battery cells are connected in a 5S2P configuration. As such, a battery pack having five of these cells in series will have an undervoltage or discharge threshold of approximately 10 volts. This undervoltage or discharge threshold is the value at which when the battery pack discharges through this threshold, the battery pack is configured to shut itself down so that the battery pack, and more specifically, the battery cells are not damaged by over discharging. As described above, the battery pack is also configured to shut itself down if the temperature of the pack or the cells exceeds a temperature threshold, for example 70° C. Also, as discussed above, if the battery pack or battery cells exceed the temperature threshold—and therefore shuts down—before the battery pack delivers or discharges its capacity, i.e., reaches its undervoltage threshold, the pack is effectively leaving energy unused. This reduces the efficiency of the user. As such, it is very desirable to have a battery pack that reaches its discharge threshold before it reaches its overtemperature threshold.

These example battery packs may be discharged at a 30-ampere constant current using a Kikusiu PLZ 1004W electronic load in relatively still ambient air of approximately 20° C.

The first example battery pack is a conventional battery pack (F) of the type described above and illustrated in FIG. 4. As illustrated in FIG. 27, as this example battery pack discharges, its temperature increases as its voltage decreases. As illustrated, when this example battery pack has discharged for 14 minutes and 24.8 seconds, its temperature has reached the 70° C. (the temperature is seen rising above the cutoff threshold due to the fact that even though the pack is shut off the nature of the cells causes the cell temperature to continue to rise for a short period of time). As also illustrated, when the battery pack reaches the 70° C. threshold/cutoff temperature, the voltage of the battery pack has only decreased to 15.94 volts. As such, the battery pack will shut down (due to reaching the temperature threshold) before it reaches its discharge threshold of approximately 10 volts.

The second example battery pack is an HDPE type battery pack (G) of the type described above and illustrated in FIGS. 5-8. As illustrated in FIG. 27, as this example battery pack discharges its temperature increases as its voltage decreases. As illustrated, when this example battery pack has discharged for 16 minutes and 8.1 seconds, its temperature has reached the 70° C. threshold/cutoff temperature (the temperature is seen rising above the cutoff threshold due to the fact that even though the pack is shut off the nature of the cells causes the cell temperature to continue to rise for a short period of time). As also illustrated, when the battery pack reaches the 70° C. threshold/cutoff temperature, the voltage of the battery pack has only decreased to 15.032 volts. As such, the battery pack will shut down (due to reaching the temperature threshold) before it reaches its discharge threshold of approximately 10 volts.

The third example battery pack is a PEO plug-type battery pack (H) of the type described above and illustrated in FIGS. 9-11. As illustrated in FIG. 27, as this example battery pack discharges its temperature increases as its voltage decreases. As illustrated, when this example battery pack has discharged for 17 minutes and 3.9 seconds, its temperature has reached the 70° C. threshold/cutoff temperature (the temperature is seen rising above the cutoff threshold due to the fact that even though the pack is shut off the nature of the cells causes the cell temperature to continue to rise for a short period of time). As also illustrated, when the battery pack reaches the 70° C. threshold/cutoff temperature, the voltage of the battery pack has only decreased to 14.652 volts. As such, the battery pack will shut down (due to reaching the temperature threshold) before it reaches its discharge threshold of 10 volts.

The fourth example battery pack is a PEO filled cell holder type battery pack (I) of the type described above and illustrated in FIGS. 20-26. As illustrated in FIG. 27, as this example battery pack discharges its temperature increases as its voltage decreases. As illustrated, when this example battery pack has discharged for 20 minutes and 0.8 seconds, it has reached its discharge threshold of approximately 10 volts before it reaches its temperature threshold (the pack temperature rises to approximately 69° C. before reaching the discharge shutdown threshold). As such, the battery pack will shut down due to reaching its discharge threshold before reaching its temperature threshold. As such, the back will provide a full discharge prior to reaching its temperature shutdown threshold.

The fifth example battery pack is a wax potted type battery pack (J) of the type described above and illustrated in FIGS. 12-19. As illustrated in FIG. 27, as this example battery pack discharges its temperature increases as its voltage decreases. As illustrated, when this example battery pack has discharged for 19 minutes and 32.9 seconds, it has reached its discharge threshold of approximately 10 volts before it reaches its temperature threshold (the pack temperature rises to approximately 59.7° C. before reaching the discharge shutdown threshold). As such, the battery pack will shut down due to reaching its discharge threshold before reaching its temperature threshold. As such, the back will provide a full discharge prior to reaching its temperature shutdown threshold.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Numerous modifications may be made to the exemplary implementations described above. These and other implementations are within the scope of this application.

1. A battery pack comprising:
a housing;
a battery core, positioned in the housing, the battery core comprising,
a set of battery cells;
a battery cell holder, the battery cell holder including
a set of battery cell receptacles, the set of battery cells received in the set of battery cell receptacle, each battery cell receptacle of the set of battery cell receptacles including a planar base,
a set of halfpipes arranged adjacent to the planar base;
a set of channels, a channel of the set of channels formed between adjacent halfpipes.

2. The battery pack, as recited in claim 1, wherein a channel of the set of channels is formed on both sides of each halfpipe of the set of halfpipes.

3. The battery pack, as recited in claim 1, wherein the battery cells of the set of battery cells have a longitudinal axis and a length along the longitudinal axis, at least one of the halfpipes of the set of halfpipes have a length approximately equal to the length of the battery cells, and at least one of the channels of the set of channels have a length approximately equal to the length of the battery cell and the length of the halfpipe.

4. The battery pack, as recited in claim 1, wherein at least one of the channels of the set of channels has a substantially triangular cross section.

5. The battery pack, as recited in claim 1, wherein each battery cell is in direct contact with at least one of the battery cell receptacles of the set of battery cell receptacles.

6. The battery pack, as recited in claim 1, wherein at least one battery cell receptacle of the set of battery cell receptacles includes an upper portion and a lower portion.

7. The battery pack, as recited in claim 6, wherein the upper portion faces the lower portion.

8. The battery pack, as recited in claim 7, wherein the halfpipes of the upper portion and the halfpipes of the lower portion form cylindrical chambers sized to form-fittingly receive at least one battery cell of the set of battery cells.

9. The battery pack, as recited in claim 1, wherein the set of battery cell receptacles has two battery cell receptacles.

10. The battery pack, as recited in claim 1, wherein at least one channel of the set of channels is formed adjacent to the planar base.

11. The battery pack, as recited in claim 3, wherein at least one channel of the set of channels extends along the length of the halfpipe and between lower portions of adjacent halfpipes.

12. The battery pack, as recited in claim 1, wherein a phase change material is in at least one of the channels of the set of channels.

13. The battery pack, as recited in claim 12, wherein the phase change material is Polyethylene Oxide (PEO).

14. The battery pack, as recited in claim 13, wherein the phase change material is paraffin wax.

15. The battery pack, as recited in claim 12, wherein the phase change material is a solid material having a melting temperature below a maximum temperature rating of the battery cells of the set of battery cells.

16. The battery pack, as recited in claim 1, wherein at least one channel of the set of channels is closed-ended on a first end and open-ended on a second end to receive the phase change material.

17. The battery pack, as recited in claim 16, wherein the phase-change material is pre-molded as an elongated bar with a substantially triangular cross-sectional shape and sized to be form-fittingly received at least one of the channels of the set of channels.

18. The battery pack, as recited in claim 16, wherein the phase-change material is poured into at least one channel of the set of channels in liquid form and allowed to solidify.

19. The battery pack, as recited in claim 16, further comprising a set of plugs, a plug of the set of plugs plugged into the open-ended second end of the at least one channel of the set of channels.
